(19) United States
(12) Patent Application Publication
(10) Pub. No.: US 2005/0011803 A1
(43) Pub. Date: Jan. 20, 2005

(54) Personal dispenser device with audio features and clock

(76) Inventor: Ann Marie Chafoulias, New Albany, OH (US)

Correspondence Address: LITMAN LAW OFFICES, LTD., P.O. BOX 15035 CRYSTAL CITY STATION, ARLINGTON, VA, 22215, US

(21) Appl. No.: 10/659,377

(22) Filed: Sep. 11, 2003

Related U.S. Application Data
(60) Provisional application No. 60/487,584, filed on Jul. 17, 2003.

(51) Int. Cl. G07F 11/00; B65D 1/09; B65D 83/04; B65D 85/42

(52) U.S. Cl. 206/528; 221/2

(57) ABSTRACT

The invention is a pill dispenser for holding a plurality of pills, with a generally elongated body with a top end and a bottom end, that is hollow to accommodate a plurality of pills kept within the generally elongated body and a bottom piece that forms a pencil tip and a knurled surface around the circumferential area of the bottom piece and is releasably attached to the bottom end of the generally elongated body. There is also a releasable cap that is removable from the top end of the generally elongated body to secure the plurality of pills within the generally elongated body and a digital clockface that is housed within the releasable cap to indicate time. There is also a pen, toothbrush and a hairbrush embodiment of the pill dispenser.

### CROSS-REFERENCE TO RELATED APPLICATION

This application claims the benefit of U.S. Provisional Patent Application Attorney Docket No. 22835.00, filed Jul. 17, 2003.

### BACKGROUND OF THE INVENTION

1. Field of the Invention

The present invention generally relates to a pill dispenser. More specifically, the invention relates to a pill dispenser with a built-in alarm and clock.

2. Description of the Related Art

Patients remembering to take their medication have always been a problem, particularly with older patients. Many patients use pill organizers to hold their medication. The related art has many pill organizers, some that also include an alarm and a clock, in addition to holding and dispensing pills.

U.S. patent application Publication No. 2002/0000917 published on Jan. 3, 2002, outlines the use of a package including a predetermined number of pills and a microprocessor. The microprocessor is preferably pre-programmed indicating when a particular pill must be taken. An alarm is associated with the microprocessor, so that when a predetermined time interval has elapsed, the microprocessor sends a signal to the alarm to activate it and thus alert the user that it is time to take a pill.

U.S. Pat. No. 4,223,801 issued to Carlson on Sep. 23, 1980, outlines the use of an automatic periodic pharmaceutical preparation dispenser, for alerting patients under medication when specific drugs are to be taken. The device provides for the orderly storage of a plurality of drugs to be taken in a given time period with a coding associated with each pill. The device further provides a timer having a signal device responsive thereto to indicate when a specific medication is to be taken and at a predetermined time relative to previously administered drugs.

U.S. Pat. No. 4,626,105 issued to Miller on Dec. 2, 1986, outlines the use of an improved and simplified pill dispenser with a plurality of compartments, each containing one or more different kinds of pills. The dispenser has a real-time clock, a control panel unique to each compartment, first and second indicators for indicating a start-up time and a time interval between pills and a time readout indicator indicating when the next pill is to be taken.

U.S. Pat. No. 4,674,651 issued to Scidmore et al. on Jun. 23, 1987, outlines the use of an apparatus for dispensing pills wherein a rotating annular element includes a number of compartments for receiving pills. When a compartment is above an opening in the base, the pills fall into a chute and are dispensed. A pin is associated with each compartment and is placed in an activated position when pills are loaded into the compartment. When the compartment is above the dispensing opening, a pin engages a micro-switch, which activates audio and visual alarms.

U.S. Pat. No. 4,690,279 issued to Hochberg on Sep. 1, 1987, outlines the use of a package for oral contraceptives that has the outward appearance of a hairbrush. A first compartment serves as a pill storage compartment, which retains a three-week supply of pills of the type that are individually packaged under a flexible bubble and is collectively mounted on a frangible support surface. The floor of the first compartment is apertured and each aperture is pill-sized and positioned in registration with a pill under a bubble.

U.S. Pat. No. 5,152,422 issued to Springer on Oct. 6, 1992, outlines the use of a dispenser for dispensing predetermined pills in sequential order that has a base with a cylindrical housing removably mounted on the base and has a pill container dispenser opening in the cylindrical housing. A pill container magazine is rotatably mounted inside the cylindrical housing and has a plurality of magazine sections thereon for holding a plurality of vertically stacked pill containers in stacked arrays.

U.S. Pat. No. 5,159,581 issued to Agans on Oct. 27, 1992, outlines the use of a medicine reminder and dispensing apparatus having a plurality of containers arranged in rows and columns in a cabinet. Each container includes a slidable base plate and a fixed wall, a drive apparatus for driving said slidable base plate in each of two directions, a microprocessor to control the dispensing apparatus in operation and an alarm connected to said micro-processor to alert a user that it is time to take or dole out a predetermined dose of medication.

U.S. Pat. No. 5,850,937 issued to Rauche on Dec. 22, 1998, outlines the use of a pill dispenser provided for alerting a user when medication must be taken. The dispenser includes a housing having a top face with at least one compartment formed therein and a lid having a first orientation for allowing access to the corresponding compartment and a second orientation for precluding access thereto. A real-time clock is situated within the interior space of the housing for tracking a present time.

U.S. Pat. No. 6,048,087 issued to Laurent et al. on Apr. 11, 2000, outlines the use of a multi-compartment electronic pillbox, which includes a microprocessor for loading prescription data into a memory. A circuit controls a display and a flag for each compartment to indicate the compartment to be used. Coded prescription data contained in a detachable data medium are loaded into the memory. Each compartment has a pill dispenser adaptable to pharmaceuticals of different forms and various sizes.

U.S. Pat. No. 6,194,995 issued to Gates on Feb. 27, 2001, outlines the use of an article dispenser with an alarm reminder device having an alarm, a clock and resettable electronic circuitry for controlling the alarm and the clock. There is a medicine cup, a substantially hollow housing having a base attached to the alarm reminder device, the housing rotatably coupled to the base, the base having the capability for transferring medicine, including a pill slide formed therethrough and a foundation having an orifice formed therein adjacent to and below the pill slide.

U.S. Pat. No. 6,510,962 issued to Lim on Jan. 28, 2003, outlines the use of a device that can be loaded with appropriate pills and is programmed to automatically dispense the proper amount and proper type of pills at the proper time each day. The device includes a system for alerting the pill taker that pills have been dispensed. There is a system for providing voice messages to coach the pill taker to use the device and consume the pills, as well as a system for alerting an off-site caregiver when the pill taker has not responded as required or when there is a problem with the operation of the device.

French Pat. No. FR 2,744,015 granted to Alonso on Aug. 1, 1997, outlines the use of a dispenser/alarm with a housing with a container for pills and an energy source in the form of a battery. The container has a duct leading to a drawer for dispensing the pills one at a time and the outside of the housing has a clock depicting the menstrual cycle. The face of the clock is divided into two sections in different colors, one graduated into 21 sections and the other graduated into 7 sections, representing the 21 days on which the pills are to be taken and the 7 rest days on which they are not taken. The clock also has an alarm which sounds and a light which flashes when a pill is to be taken, with both the noise and light ceasing once the drawer is opened.

German Pat. No. DE 19,652,202 granted to Rivet on Jun. 25, 1998, outlines the use of an electrical pill or medicine box that has a casing and a display indicating the time of the last or next occasion of taking medication. Preferably, the display is externally visible, especially in the cover. The time indicated is the date and/or time of the occasion. A switch advances the date and/or time. The number of doses to be taken is indicated and a cover switch operates a dose counter. The number of doses taken is also displayed. There is a clock and date display, as well as a reminder and alarm function, the alarm being optical or acoustical.

W.I.P.O. Pat. No. WO 00/56264 granted to Abry et al. on Sep. 28, 2000, outlines the use of a pill dispenser, which includes a clock element and a pill-dispensing element. The clock element includes a programmable clock connected to one or more signal transmitters and one or more acknowledgement or reset switches for resetting the signal and a memory module for registration of signals from the acknowledgement or reset switches. The pill-dispensing element includes one or more pill receptacles, each including a dispensing method for dispensing pills. The dispensing method of the pill receptacles includes an insert shaped to prevent more than one pill being dispensed at a time and a sliding damper, which may be moved manually or automatically between a closed position, in which dispensing of the pill is prevented, and an open position, in which the pill is dispensed.

Although each of these patents outlines the use of novel and useful devices, what is really needed is a pill dispenser that can be used as a pen, pencil, toothbrush, hairbrush or similar device. The pill dispenser would also have to have an alarm and clock to work effectively and meet the demand for the device in the marketplace.

None of the above inventions and patents, taken either singly or in combination, is seen to describe the instant invention as claimed. Thus a personal dispenser device with audio features and a clock solving the aforementioned problems is desired.

### SUMMARY OF THE INVENTION

The invention is a pill dispenser for holding a plurality of pills, with a generally elongated body with a top end and a bottom end, that is hollow to accommodate a plurality of pills kept within the generally elongated body and a bottom piece that forms a pencil tip and a knurled surface around the circumferential area of the bottom piece and is releasably attached to the bottom end of the generally elongated body. There is also a releasable cap that is removable from the top end of the generally elongated body to secure the plurality of pills within the generally elongated body and a digital clockface that is housed within the releasable cap to indicate time.

Accordingly, it is a principal object of the invention to provide a pill organizer that reminds users when to take their medication.

It is another object of the invention to provide a pill organizer that can be programmed to remind users of specific times when to take their medication.

It is a further object of the invention to provide a pill organizer with an audio alarm as well as a visual alarm for users to take their medication.

Still another object of the invention is to provide a pill organizer in the form of a pen, pencil, toothbrush or hairbrush.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of the first embodiment of a pill dispenser with an alarm and clock, according to the present invention.

FIG. 2 is a front perspective exploded view of the first embodiment of a pill dispenser with an alarm and a clock.

FIG. 3 is a listing of the different functional bottom pieces of a pill dispenser with an alarm and clock.

Similar reference characters denote corresponding features consistently throughout the attached drawings.

### DETAILED DESCRIPTION OF THE PREFERRED EMBODIMENTS

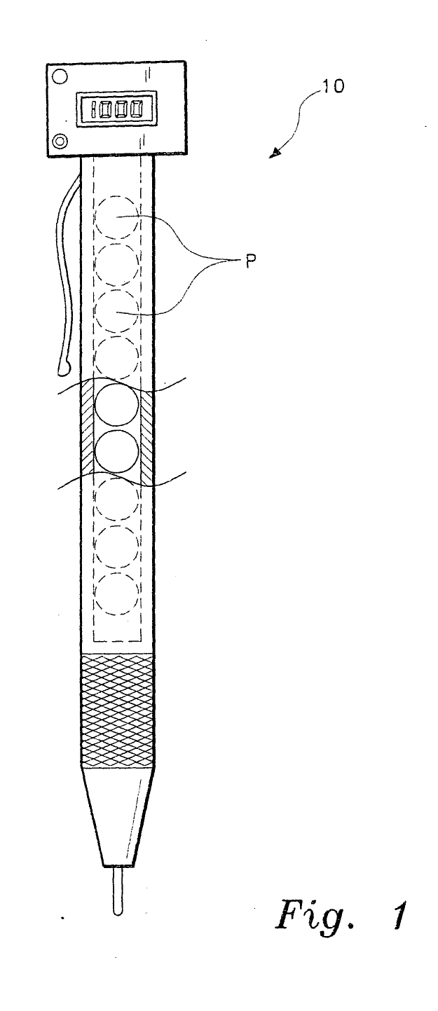

The present invention is a pill dispenser 10 for holding a plurality of pills P, as is shown in FIG. 1.

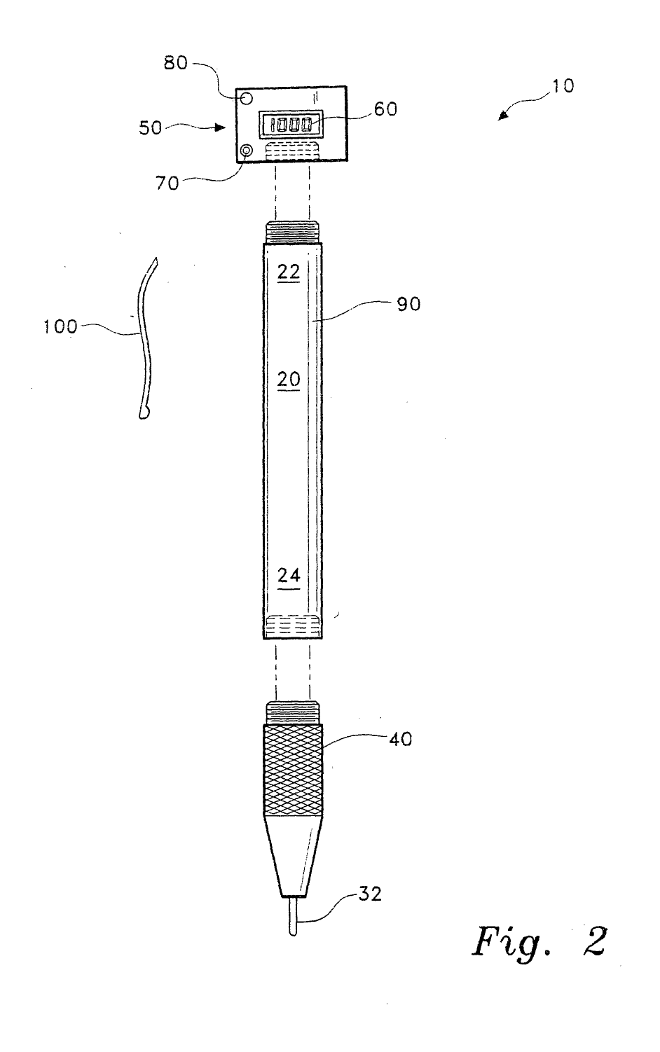

According to FIG. 2, the pill dispenser 10 comprises a generally elongated body 20 with a top end 22 and a bottom end 24 that is hollow to accommodate the plurality of pills P kept within the generally elongated body 20. The pill dispenser 10 further comprises a functional bottom piece 30 with a circumference, that forms a pencil tip 32 and a knurled surface 40 around the circumferential area of the functional bottom piece 30 and is releasably attached to the bottom end 24 of the generally elongated body 20. There is also a releasable cap 50 that is removable from the top end 22 of the generally elongated body 20 to secure the plurality of pills P within the generally elongated body 20. The pill dispenser 10 further comprises a digital clockface 60 that is housed within the releasable cap 50 to indicate time, a plurality of alarm components 70 that are integral with the digital clockface 60 is also housed within the releasable cap 50 and a LCD light 80 that indicates that the plurality of alarm components 70 have been activated.

The generally elongated body 20 can be screwed together by hand to with the releasable cap 50 and the functional bottom pieces 30, thereby forming the entire pill dispenser 10. The generally elongated body 20 has a transparent window 90 that allows a user to easily see any of a plurality of pills P that are stored in the generally elongated body 20. The transparent window 90 covers the generally elongated body 20 and can use a hinge or snap mechanism (not shown) to open and close the transparent window 90. The generally elongated body 20 is a storage area for the plurality of pills P that may be stored in the pill dispenser 10. The first embodiment of the pill dispenser 10 has a functional bottom piece 30 that is a pencil tip 32 and a knurled surface 40. The knurled surface 40 is to make the pill dispenser 10 easier to hold and grip. There is also a clip 100 on the outside of the generally elongated body 20 to secure the pill dispenser 10 while in a user's pocket.

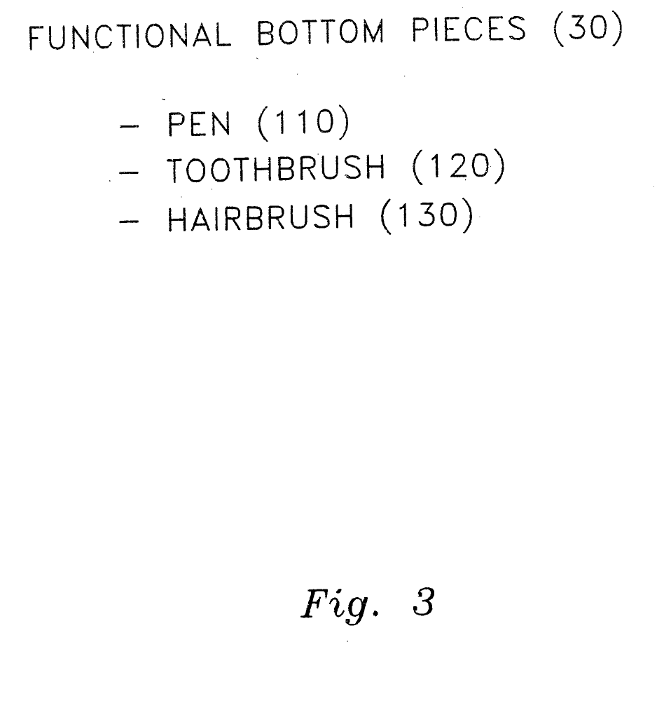

FIG. 3 outlines the other embodiments of the pill dispenser 10. These other embodiments include an embodiment for a pen 110, a toothbrush 120 and a hairbrush 130. Each of the different embodiments have different bottom pieces 30. The pen embodiment 110 has a functional bottom piece 30 that is a pen point (not shown) and a knurled surface 40. The toothbrush embodiment 120 has a functional bottom piece 30 that is a toothbrush head with bristles (not shown) and the hairbrush embodiment 130 has a functional bottom piece 30 that is a hairbrush head with bristles (not shown). Each of the functional bottom pieces 30 can be easily screwed on and off of the bottom end 24 of the generally elongated body 20 and are interchangeable. Other parts of the pill dispenser 10 are the same for each embodiment. The generally elongated body 20 and the releasable cap 50 and their components are identical for each embodiment of the pill dispenser 10.

Use of all embodiments of the pill dispenser 10 is straightforward. Users can set the plurality of alarm components 70 and fill the generally elongated body 20 manually with a plurality of pills P. The plurality of alarm components 70 will activate a LCD light 80 when a set time is reached. The releasable cap 30 can also be manually screwed on and off for loading and reloading the plurality of pills P in the generally elongated body 20. A user can set the plurality of alarm components 70 for anytime as a reminder for taking some medication. The plurality of alarm components 70 includes an alarm set button (not shown), a battery (not shown), as well as an alarm beeper (not shown). The generally elongated body 20 and releasable cap 50 and their components are provided on the pen embodiment 110, the toothbrush embodiment 120 and the hairbrush embodiment 130, which all have alarm capability. The alarm capability can be used to remind the user to take a medication at a particular time or can be used to time how long it takes to do something, such as timing how long it takes for a person to brush their teeth.

It is to be understood that the present invention is not limited to the embodiments described above, but encompasses any and all embodiments within the scope of the following claims.

1. A pill dispenser for holding pills, comprising:
a generally elongated body with a top end and a bottom end, that is hollow to accommodate a plurality of pills kept within the generally elongated body;
a bottom piece with a circumference, that forms a pencil tip and a knurled surface around the circumferential area of the bottom piece and is releasably attached to the bottom end of the generally elongated body;
a releasable cap that is removable from the top end of the generally elongated body to secure the plurality of pills within the generally elongated body;
a digital clockface that is housed within the releasable cap to indicate time;
a plurality of alarm components that are integral with the digital clockface and the alarm that is also housed within the releasable cap; and
a LCD light that indicates that the plurality of alarm components have been activated.

2. The pill dispenser according to claim 1, wherein the generally elongated body has a transparent window.

3. The pill dispenser according to claim 2, wherein the transparent window is attached to the generally elongated body by a hinge.

4. The pill dispenser according to claim 2, wherein the transparent window is attached to the generally elongated body by a snap mechanism.

5. The pill dispenser according to claim 1, wherein the functional bottom piece is a pen tip and a knurled surface.

6. The pill dispenser according to claim 1, wherein the functional bottom piece is a toothbrush head.

7. The pill dispenser according to claim 1, wherein the functional bottom piece is a hairbrush head.

8. The pill dispenser according to claim 1, wherein a securing clip is attached to the generally elongated body of the pill dispenser.
